(19) United States
(12) Patent Application Publication
(10) Pub. No.: US 2006/0123720 A1
(43) Pub. Date: Jun. 15, 2006

(54) Fiberglass cover for a door frame component

(75) Inventor: George S. Liu, Duluth, GA (US)

Correspondence Address: STANDLEY LAW GROUP LLP, 495 METRO PLACE SOUTH, SUITE 210, DUBLIN, OH, 43017, US

(73) Assignee: Evermark LLC

(21) Appl. No.: 11/326,530

(22) Filed: Jan. 5, 2006

Related U.S. Application Data
(63) Continuation-in-part of application No. 10/981,933, filed on Nov. 5, 2004.

(51) Int. Cl. E06B 1/04

(52) U.S. Cl. 52/211

(57) ABSTRACT

A door frame component may have a main portion which may have a first portion and second portion. A fiberglass cover member may be disposed on the main portion. The fiberglass cover may provide additional protection from the elements to the main portion. The fiberglass cover may be matched to a fiberglass door in grain, pattern, finish and/or stain.

### CROSS-REFERENCE TO RELATED APPLICATIONS

This application is a continuation-in-part of application Ser. No. 10/981,933, filed Nov. 5, 2004.

### BACKGROUND AND SUMMARY OF THE INVENTION

The present invention is directed to door frames, and more particularly to door frame components that increase both the aesthetic and structural integrity of a door frame and reduce maintenance requirements.

A conventional exterior door frame typically includes a door jamb system. The door jamb system provides a weather-tight seal between the interior and exterior of a building when a door attached thereto is shut within the frame. The jamb system includes vertical jamb legs that are located along the inner peripheral vertical edges of the frame and abut the side edges of the door when the door is shut within the frame. A jamb header is located along the top inner periphery of the door frame and abuts the top edge of the door when the door is shut into the frame. The jamb legs and jamb header also typically include some form of weather strip to prevent air and other outdoor elements from entering the building interior when the door abuts the jamb legs and header. In addition to providing the weather-tight seal, the jamb legs and header prevent the door from swinging through the frame.

Because an exterior door frame acts as an interface between the building interior and exterior, the associated jamb system is continually exposed to harsh conditions, such as moisture, sunlight and temperature extremes, which typically cause damage to and decrease the useful life of the jamb system. Components of the door frame system, such as, jambs, mullions, astragals and brick moulding, may also have important aesthetic functions since they are visible at the entrance to a building or structure. Therefore, system components must be protected from such conditions to ensure structural longevity and aesthetic quality.

Several approaches have been used in the past to protect jamb system components. In a traditional approach, wood-based door jambs are covered with paint, varnish or other wet applied protective coatings. However, such wood-based preservative systems require periodic reapplication and typically only provide marginal protection to the jamb.

In another approach, film or laminate envelopes are applied over door jambs and bonded thereto with adhesives. However, such coverings leave unattractive edges when the jamb is machined for the addition of hinges and strike holes. Further the adhesives often become detached from the jambs due to moisture seepage and thermal bow caused by extreme temperature differences between the interior and exterior of the building.

In yet another approach, to overcome the above-mentioned problems associated with wood-based door jamb systems, door jamb systems manufactured from solid cellular plastic material, hollow rigid plastic materials or composite materials have been produced. Door jamb systems made from such materials do not require the periodic reapplication of wet applied protective coverings, nor do such plastic-based systems require any type of protective covering. However, door jambs made from such synthetic materials often lack the structural integrity of wood-based door jambs—they often wobble or bow after a short period. In addition, such systems are typically vulnerable to thermal bow and thermal expansion and contraction. As a result, doors mounted within frames having such jamb systems typically do not fit in a weather-tight manner once the jamb system has been subjected to such conditions.

In another approach, door jamb clads manufactured from steel, aluminum or plastic have been used to cover portions of wood-based door frames to protect the door frames from exposure to extreme weather conditions. However, a typical door jamb clad covers only a part of the door frame, thereby requiring a high quality substrate, such as wood, to be used as the frame itself to maintain both the structural and aesthetic integrity of the frame. Further, such door jamb clads typically require a time consuming installation procedure, thereby increasing the associated cost of the door frame system.

Therefore, it would be desirable to provide a door frame having a clad/jamb system that is integrally attached to the door frame to enhance both the structural and aesthetic qualities of the door frame and to permit the frame to be constructed of a material less expensive than high quality wood while maintaining frame structural integrity. It would also be desirable to provide a door frame having a clad/jamb system that makes the frame less susceptible to changes caused by exposure to extreme weather conditions and thereby increases the overall life of the frame. With the rising popularity of fiberglass doors, it would also be desirable to match the finish and grain of door frame components with that of the fiberglass door. In view of the present disclosure or through practice of the present invention, other advantages may become apparent.

Exemplary embodiments of the present invention may include a component for use with a door frame that may have a door hingedly attached thereto having, a main portion having a first portion having a first edge and a second edge and a second portion having a third edge, a fourth edge and being disposed on the first portion and a fiberglass cover member extending from about the first edge over the first portion to at least the second portion.

In one embodiment, cover member may extend over at least the first, second, third and fourth edges. The first portion may include a channel. The door may be made from fiberglass. One embodiment may also include having a stain on the door and component where the stains are substantially similar. The door and component may also match in texture, pattern and/or color.

In one embodiment the main portion may extend along the entire length of the jamb. The component may be a jamb, a mullion, a t-astragal, a brick mould or other similar door frame components. In one embodiment cover member may be adhered to the first portion with an adhesive and may be flush against the first portion. The cover member may be up to about ½ inch thick or between about 1/32 inch and about ½ inch thick. The cover member may be exposed to outdoor conditions and the second portion may be exposed to indoor conditions.

Exemplary embodiments of the present invention may also include, a door frame assembly which may have a plurality of vertical jamb legs, a jamb header connected to the plurality of vertical jamb legs, a door hingedly attached to one of the plurality of vertical jamb legs, at least one of the plurality of vertical jamb legs having a body portion and a doorstop portion which extend the length of said vertical jamb leg and a fiberglass cover member adhered at least to the doorstop portion. The doorstop portion may also have disposed therein a channel. One embodiment may also include a door jamb system which may have a plurality of vertical wood jamb legs, a jamb header connected to the plurality of vertical jamb legs, a fiberglass door hingedly attached to one of the plurality of vertical jamb legs, at least one of the plurality of vertical jamb legs having a body portion and a doorstop portion which extend the length of the vertical jamb leg and which form an L-shaped cross section and a fiberglass cover member adhered to said doorstop portion, wherein the door and cover member may have a stain and wherein the stains may be substantially similar.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 depicts a door frame illustrating the use of a component constructed in accordance with one embodiment of the present invention.

FIG. 2 depicts a cross section of a component constructed in accordance with one embodiment of the present invention.

FIG. 3 is an orthogonal view of a component in accordance with one embodiment of the present invention.

FIG. 4 is an orthogonal view of a component in accordance with one embodiment of the present invention.

FIG. 5 is an orthogonal view of a component in accordance with one embodiment of the present invention.

FIG. 6 is an orthogonal view of a component in accordance with one embodiment of the present invention.

### DETAILED DESCRIPTION OF THE EXEMPLARY EMBODIMENT(S)

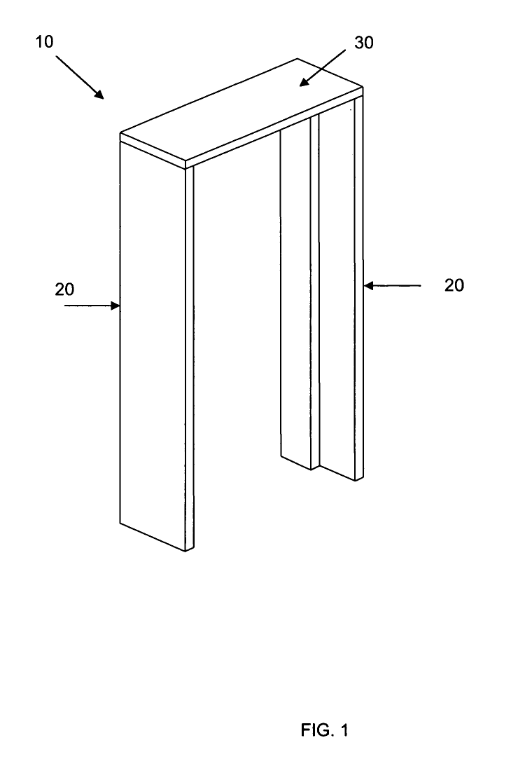

FIG. 1 presents a door frame assembly 10 having vertical jamb legs 20 whose upper ends are connected to jamb header 30 to form a door frame. Although the following discussion centers about vertical jamb legs 20, it should be understood that jamb header 30 may be similarly constructed. In one embodiment, door frame assembly may be a pre-hung door and frame system, where a door may be pre-hung on the frame shown in FIG. 1. In another embodiment, door frame assembly 10, which may include a door, a frame and a cover member may be pre-built or pre-assembled as a unit at a factory for installation into a frame opening at a job-site.

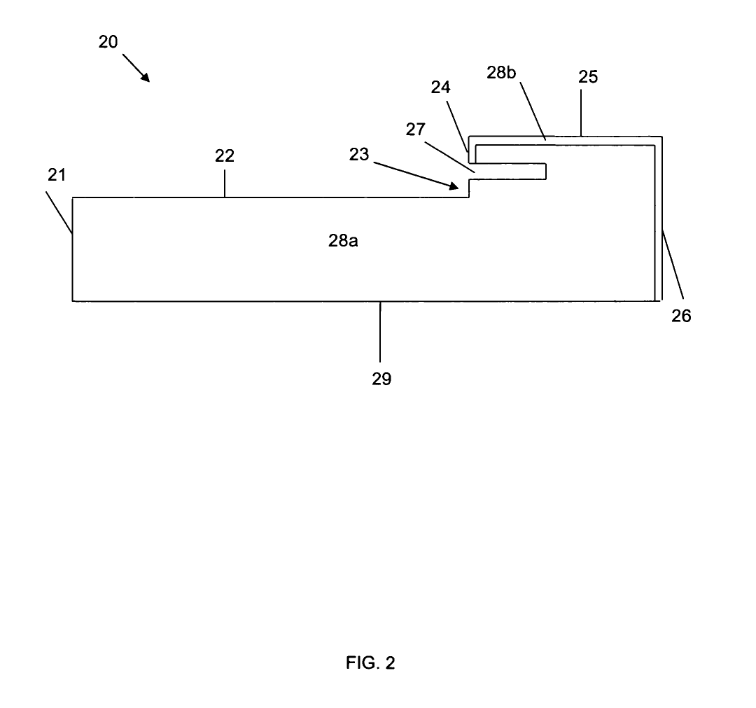

FIG. 2 illustrates the cross section of vertical jamb leg 20 in accordance with one embodiment of the present invention. Vertical jamb leg 20 has a plurality of surfaces 21, 22, 24, 25, 26 and 29 defining its exterior. The vertical jamb leg 20 is comprised of two portions, a main portion 28a and a cover portion 28b. Main portion 28a is divided into two portions, a body portion (defined by the cross sectional area of surfaces 21 and 29) and a doorstop portion (defined by the cross sectional area of surfaces 24 and 25). The main portion may extend along the length of the jamb.

When used in an exterior door jamb system, vertical jamb leg 20 is situated such that surfaces 25 and 26 are exposed to the outside of the building, while surfaces 21 and 22 are exposed to the inside of the building. Typically, the hinges and strike plate for mounting a door are disposed on surface 22. The intersection of surfaces 22 and 24 define inside corner 23. This may give main portion 28a an L-shaped cross section. Surface 24 acts as a doorstop upon which a door (not shown) hung in the door jamb system rests against when closed. An optional groove 27 may be disposed in surface 24 to accommodate the insertion of weather-stripping to improve the seal between a door and the door frame.

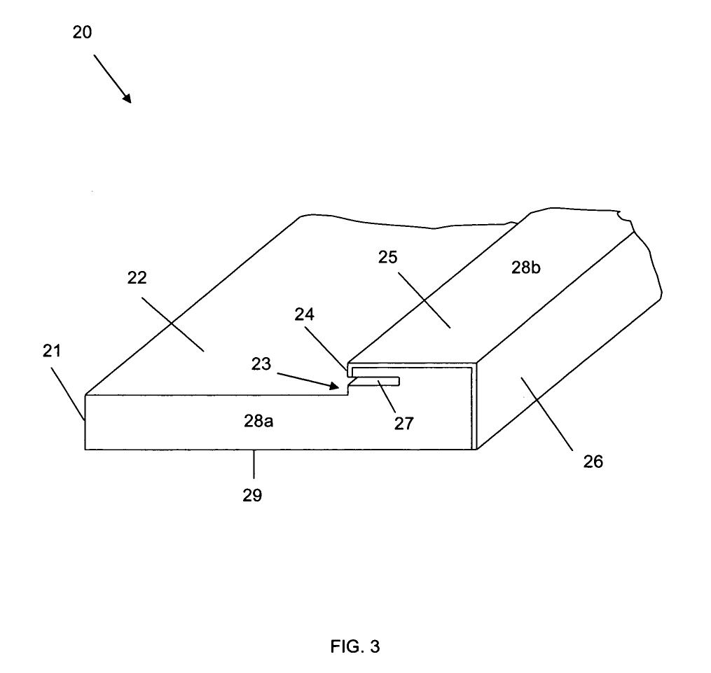

FIG. 3 presents an orthogonal view of an end section of the vertical jamb leg 20 for ease of visualization. The vertical jamb leg of the present invention is fabricated by providing a main portion and adhering thereto a cover portion. By controlling the tolerances of the main portion and the cover portion (control of which is readily understood by one of ordinary skill in the respective arts), a good fit between the main portion and the cover portion may be effected. By having components that naturally fit well together, the adhesive used to bond the two components has a better effectiveness and the quantity of adhesive required for each vertical jamb leg may be minimized—thereby suppressing manufacturing costs.

The cross section of the cover portion 28b is controlled through known fabrication techniques such as extruding; however, other suitable techniques may be employed. Although FIG. 2 shows that the cover portion 28b extends from the intersection of surfaces 26 and 29 to the intersection of surface 24 and groove 27 (nearest the intersection of surface 24 and 25), the cover portion may be extended so as to extend onto surface 29, to inside corner 23 and/or onto surfaces 22 and 21. In those embodiments where cover portion 28b extends to or beyond inside corner 23, groove 27 may be milled after the adhesion of the cover portion 28b to the main portion 28a.

In one embodiment, the main portion 28a is constructed from a single piece of wood; however, it may be constructed from a plurality of staves connected to one another in an end-to-end arrangement so as to mimic the use of a single piece of wood. Main portion 28a may also be formed from steel, plastic or any other similar building material. The cross section of the main portion 28a is created through known fabrication techniques such as milling; however other suitable techniques may be employed. It is not intended that the cross section of the main portion 28a used in the present invention is limited to that which is disclosed herein, but rather that the main portion may have a variety of possible cross sectional configurations, so long as the main portion has disposed thereupon - either unitarily or affixed thereto—a doorstop portion so as to define that portion of the jamb which is exposed to the outdoors and that portion which is exposed to the interior of the building.

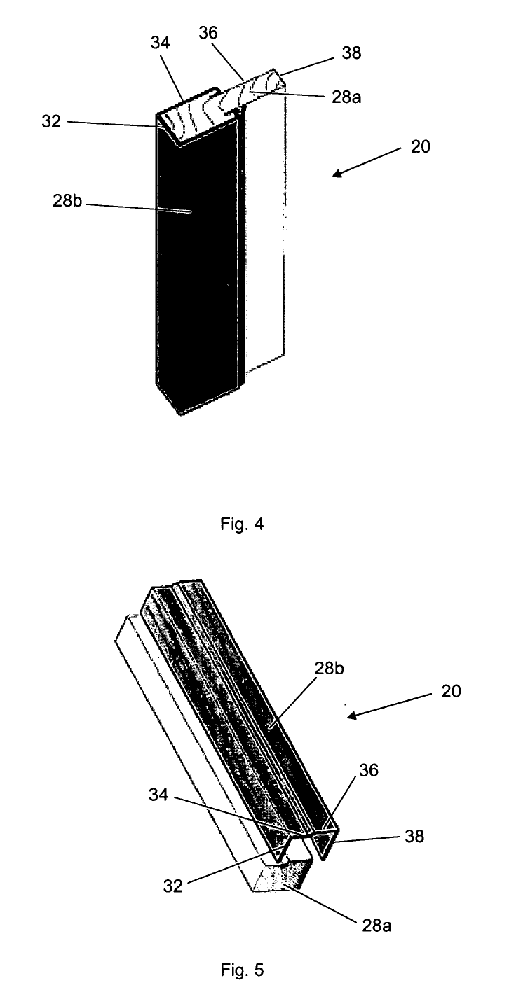

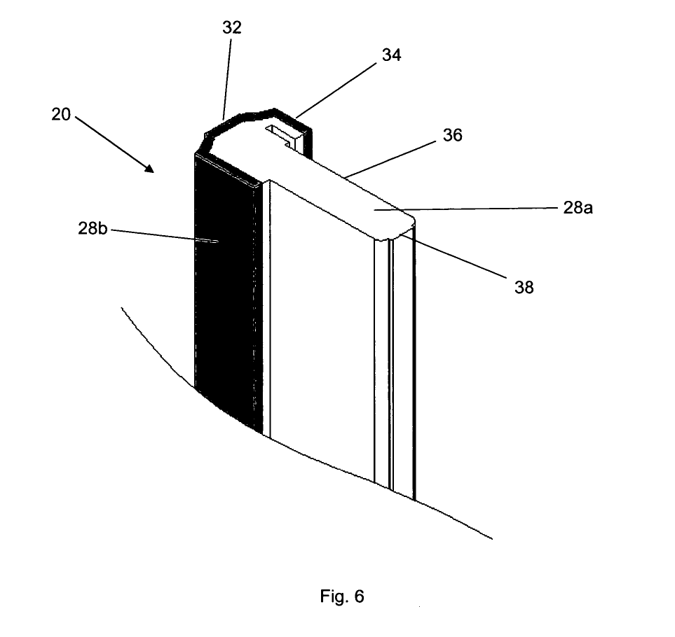

FIGS. 4-6 show additional embodiments of the present invention. Component 20 may be divided into two portions, main portion 28a and cover portion 28b. Main portion 28a may be divided into two portions, a first portion (defined by the cross sectional area of first edge 32 and second edge 34) and a second portion (defined by the cross sectional area of third edge 36 and fourth edge 38). Main portion 28a may extend along the length of the jamb. Fiberglass cover portion may extend from first edge over the first portion to the second portion. In one embodiment, fiberglass cover portion 28b may extend over the entire first portion. In another embodiment, fiberglass cover portion 28b may extend over the entire first and second portions. In another embodiment fiberglass cover portion 28b may extend over portions of the first and second portions. The component may be a jamb, mullion, t-astragal, brick mould or other door frame components. A mullion may be a vertical member between openings in a multiple opening door frame. An astragal may be attached to one or both doors of a pair at their meeting or vertical edges. The astragal may close the clearance gap between the doors and may hold a weather seal, which minimizes the passage of light or air between the doors. A brick mould may be a decorative exterior moulding attached to door frames that may abut the facing material (brick or other siding material) of the structure. It may be applied to the left, top and/or right sides of the frame to hide the gap between the frame and the siding.

In one embodiment, the cover portion 28b is constructed from a material such as polypropylene, polyethylene, polyvinylchloride, fiberglass, wood composite, aluminum or any other suitable durable, moisture, decay and insect resistant material. Additionally, cover portion 28b may be made flush against the surface to which it is adhered. The cover portion 28b may be any desired thickness. Exemplary thicknesses may be between 1/32^{nd} of an inch and ½ inch. Suitable adhesives for attaching the cover portion to the body portion include Titebond Polyurethane glue produced by Franklin International; however, any adhesive capable of maintaining adhesion throughout the temperature and humidity cycles that the cover portion of the jamb will be exposed to may be used.

The present invention may be made with a smooth or wood-grain surface. This surface may be finished in a variety of colors by painting or staining. In particular, fiberglass cover may be designed to match a fiberglass door to which it is assembled in both grain pattern and color. Manufacturing the component out of fiberglass allows the stain to be absorbed into the material. This allows the fiberglass door and component to be stained with the same stain, where both the door and component absorb the stain in a similar way, achieving a substantially similar look. This allows both the door and component to have the same traditional look of wood, while having increased durability, better insulation performance, improved resistance to the elements and low maintenance. Fiberglass may also allow the door and component to remain matched for a longer period of time, as the finish on fiberglass products lasts longer than traditional wood finishes.

While certain embodiments of the present invention are described in detail above, the scope of the invention is not to be considered limited by such disclosure, and modifications are possible without departing from the spirit of the invention as evidenced by the following claims:

What is claimed is:

1. A component for use with a door frame that has a door hingedly attached thereto, comprising:
a main portion comprising a first portion having a first edge and a second edge and a second portion having a third edge, a fourth edge and being disposed on said first portion; and
a fiberglass cover member extending from about said first edge over said first portion to at least said second portion.

2. The component for use with a door frame according to claim 1 wherein said first portion has disposed therein a channel.

3. The component for use with a door frame according to claim 1 wherein said door is made from fiberglass.

4. The component for use with a door frame according to claim 3 wherein said door and said cover member each absorb a stain and wherein said stains are substantially similar.

5. The component for use with a door frame according to claim 3 wherein said door and said cover member substantially match in a feature selected from the group consisting of, texture, pattern and color.

6. The component for use with a door frame according to claim 1 wherein said main portion extends along the entire length of the jamb.

7. The component for use with a door frame according to claim 1 wherein said component is selected from the group consisting of a jamb, a mullion, a t-astragal, a brick mould and other similar door frame components.

8. The component for use with a door frame according to claim 1 wherein said cover member is adhered to said first portion with an adhesive and is flush against said first portion.

9. The component for use with a door frame according to claim 1 wherein said cover member is up to about ½ inch thick.

10. The component for use with a door frame according to claim 1 wherein said cover member is exposed to outdoor conditions and said second portion is exposed to indoor conditions.

11. The component for use with a door frame according to claim 1 wherein said cover member extends over at least said first, second, third and fourth edges.

12. A door frame assembly comprising:
a plurality of vertical jamb legs;
a jamb header connected to said plurality of vertical jamb legs;
a door hingedly attached to one of said plurality of vertical jamb legs;
at least one of said plurality of vertical jamb legs having a body portion and a doorstop portion which extend the length of said vertical jamb leg; and
a fiberglass cover member adhered at least to said doorstop portion.

13. The door frame assembly according to claim 12 wherein said doorstop portion has disposed therein a channel.

14. The door frame assembly according to claim 12 wherein said door is made from fiberglass.

15. The door frame assembly according to claim 14 wherein said door and said cover member each have a stain and wherein said stains are substantially similar.

16. The door frame assembly according to claim 12 wherein said cover member does not cover any part of the body portion.

17. The door frame assembly according to claim 12 wherein said cover member is adhered to said doorstop portion with an adhesive and is flush against said doorstop portion.

18. The door frame assembly according to claim 12 wherein said cover member is between about 1/32 inch and about ½ inch thick.

19. The door frame assembly according to claim 12 wherein said cover member is exposed to outdoor conditions and said body portion is exposed to indoor conditions.

20. A door jamb system comprising:
a plurality of vertical wood jamb legs;
a jamb header connected to said plurality of vertical jamb legs, said vertical jamb legs and said jamb header forming a door frame;
a fiberglass door hingedly attached to one of said plurality of vertical jamb legs thereby providing a pre-hung door on said door frame;
at least one of said plurality of vertical jamb legs having a body portion and a doorstop portion which extend the length of said vertical jamb leg and which form an L-shaped cross section;
a fiberglass cover member adhered to said doorstop portion;
wherein said door and said cover member each have a stain and wherein said stains are substantially similar; and
wherein said pre-hung door, frame and fiberglass cover member are pre-assembled and adapted to be installed as a unit into a frame opening.
